(19) United States
(12) Patent Application Publication
(10) Pub. No.: US 2008/0062824 A1
(43) Pub. Date: Mar. 13, 2008

(54) Optical Head with a Variable Optical Component

(75) Inventors: Robert Frans Maria Hendriks, Eindhoven (NL); Ralph Kurt, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/571,535

(22) PCT Filed: Jun. 22, 2005
(86) PCT No.: PCT/IB05/52048

§ 371 Date: Jan. 2, 2007

(30) Foreign Application Priority Data
Jul. 6, 2004 (EP) 04103189.9

(51) Int. Cl. G11B 7/00

(52) U.S. Cl. 369/44.14

(57) ABSTRACT

An optical head (10) using a variable optical component (10), which component comprises bendable nano-elements (3) that can be switched between a bent and non-bent state by means of a driver-field applied between electrodes (1, 2). In the bent state the nano-elements absorb radiation and therefore adapt the radiation intensity distribution of the radiation beam passing the component.

The present invention relates to an optical head comprising a variable optical component that alters the intensity distribution in a beam of radiation bent. The invention also relates to a variable optical component for such an optical head and to an optical system using the optical head.

### BACKGROUND OF THE INVENTION

In optical storage data applications, such as for the formats CD, DVD and Blu-ray Disc (BD), the playback and recording of data from and into the storage medium puts different requirements on the optical spot on the disc. During playback, the dimensions of the optical spot focused on the information layer determine the readout resolution, i.e. the mark (pit) size that is still readable. During recording, the rise in temperature of the recording layer in the disc due to the amount of focused radiation in the optical spot plays a major role and the spot size is less critical. These different requirements between playback and recording translate to requirements on the intensity and its distribution in the pupil plane of the objective lens used for focusing the radiation beam onto the information or recording layer in the medium. The rim-intensity is the relative intensity at the edge (or rim) of the pupil as compared to the maximum intensity of the radiation distribution in the pupil plane. For playback a high rim-intensity is required to achieve a small spot and thus a high readout resolution. This requirement can be different for the tangential direction (i.e. direction of the scanning spot in the disc parallel to the tracks) and the radial direction (i.e. direction of the scanning spot in the disc perpendicular to the tracks) depending on the distance between the tracks and the dimensions of the pits in the track. For recording the total amount of radiation is important.

The radiation sources used in optical storage applications are commonly semiconductor laser diodes. A well-known characteristic of these laser diodes is their elliptically shaped far-field intensity distribution. This distribution can be characterized by the full width at half maximum (FWHM) divergence angles in the two relevant directions with respect to the laser diode chip: the parallel direction and perpendicular direction. Commonly used high power lasers for CD and DVD have FWHM values of about 9 degrees in the parallel direction and about 17 to 18 degrees in the perpendicular direction. The currently available lasers for the so-called Blu-ray Disc (BD) system have an even stronger ellipticity, because as the typical far-field intensity distribution has a FWHM value of about 10 degrees in the parallel direction and a FWHM of about 25 degrees in the perpendicular direction.

For a good readout quality of the discs minimum rim-intensities are required in both the tangential and the radial direction. These requirements are the strongest for the latest high data density optical disc systems such as BD, where the minimum rim-intensity requirement is about 65% in both directions. Then only a relatively small part of the laser radiation emitted by the laser is effectively being used. With this minimum of 65% for the rim-intensity the beam divergence in the parallel direction will be the limiting parameter with respect to the usable part of the emitted laser radiation. Having a circular pupil with a 65% rim-intensity in relation to the parallel far-field direction of the laser, the rim-intensity related to the perpendicular far-field direction of a commonly used laser for BD is about 95%. This means that the effective use (coupling efficiency) of the emitted radiation by the laser is low (only about some 14%), which is not favorable for a recording system, as it requires a laser with a high output power rating.

In the optical system of an optical data storage application, such as an optical recording system, a collimator lens is commonly used for collimating the divergent radiation-beam emitted by the laser. The numerical aperture of this collimator lens determines the amount of radiation coupled effectively into the optical system: i.e. the coupling efficiency.

For recording purposes a high coupling efficiency is needed, but as is clear from the above example this can result in low rim-intensities for playback purposes. A beam shaper can transform the ellipticity of the intensity distribution to a more circular intensity distribution. Commonly used beam shapers are anamorphic prism pair and lens-type beam shapers. With this more circular intensity the coupling efficiency can be increased while still having the same minimum requirement on rim-intensity of for example the 65% for BD. The coupling efficiency can then be increased with a factor two to 28%. This means that the required total laser radiation output power could be lower than in an optical system without a beam shaper. This is favorable with respect to for example, availability of lasers, power consumption and dissipation, laser lifetime, etc.

Another characteristic of the semiconductor laser diodes is that the laser noise (high frequency output power fluctuations) is decreasing with increasing output power. The influence on the readout performance of optical data storage applications increases with higher readout speed. To guarantee a minimum SNR (Signal to Noise Ratio) of the readout signal the laser has to operate at a minimum radiation output power.

On the other hand the maximum radiation power during playback of a recordable disc is limited by the fact that the recorded data should not be erased. This in combination with a high coupling efficiency, as required for an optical recording system, can result is a total laser output power during playback that is too low for stable laser output operation. The SNR will then become low and this limits the readout performance of the optical disc system (for example, limiting the readout speed).

As optical data storage applications are usually supporting a combination of multiple disc formats, such as BD and DVD playback and recording, the above-described requirements are needed for each supported disc format. However, the requirements differ for each system due to different characteristics of the systems, such as data density on the disc, track distance, pit sizes, numerical aperture of the objective lens (for focusing the radiation beam into the media), the media sensitivity, as well the required wavelength for the disc format. For CD the wavelength used is about 785 nm, for DVD this is about 650 nm and for BD this is about 405 nm.

US Patent Application 2003/0169667 discloses a recording and playback apparatus in which the total laser power during playback is increased while not increasing the total required laser power during recording. By implementing a variable optical coupling efficiency device into the optical head of the playback and recording apparatus, the coupling efficiency is switched from a low level during playback to a high level during recording. Various examples of variable optical coupling devices are described, either switchable by electrical means or by mechanical means. The variable optical coupling efficiency device disclosed does give a solution for the improved SNR of the readout system by lowering the transmission efficiency from the radiation source to the disc via attenuation, diffraction, etc., but gives no solution for the different requirements concerning the playback and recording parameters related to rim-intensity and coupling efficiency.

It is an object of the invention to provide an improved recording and playback apparatus with an optical head that has a high coupling efficiency during recording and low laser noise conditions during playback.

### SUMMARY OF THE INVENTION

According to the invention this object is realized in that the optical head comprises a radiation source for emitting a radiation beam, a lens for focusing said emitted radiation onto a medium, and a variable optical component for varying the intensity distribution of the radiation beam entering the lens, said radiation beam having a cross section at the location of the variable optical component and that the variable optical component comprises an electrode-configuration of electrodes for generation of a driver-field and bendable nano-elements which are switchable between a non-bent state and a bent state by means of that driver-field.

In the context of this application, a driver-field may be an electric field or a magnetic field as well as combinations thereof, dependent on the nature of the bendable nano-elements.

Nano-element is a general term for a nanotube and a nanowire, also called whisker, and a small prism and have been described in several papers for a variety of materials, such as indium phosphide (InP), zinc oxide (ZnO), zinc selenide (ZnSe), boron nitride (BN), silicon carbide (SiC) and carbon (C). Nano-elements are very small bodies having a hollow (nanotubes) or filled (nanowires) cylindrical or prismatic shape having a smallest dimension, for example a diameter, in the nanometer range. These bodies have a symmetry axis, the orientation of which determines its electrical and optical properties. Bendable nano-elements usually have a longer dimension in the direction of the symmetry axis than in other directions.

In such a device the bendable nano-elements all have their symmetry axis in the non-bent state substantially parallel. Small deviations of nano-elements to this one direction are possible without affecting the optical behavior of the variable optical component.

Particularly carbon nanotubes have been studied well. They are single layer or multiple layer cylindrical structures basically graphite (sp2-) configured carbon. The existence of both metallic and semi-conducting nanotubes has been confirmed experimentally. Furthermore, it has recently found that single walled carbon nanotubes having a thickness of, for example 0.4 nm, aligned in channels of an AIPO₄-5 single crystal exhibit optical anisotropy. Carbon nanotubes are nearly transparent for radiation having a wavelength in the range of 1.5 μm down to 200 nm and having a polarization direction perpendicular to the tube axis. They show strong absorption for radiation having a wavelength in the range of about 600 nm down to 200 nm and having a polarization direction parallel to the tube axis (Li, Z. M. et al., Phys. Rev. Lett. 87(2001), 1277401-1/4).

Nanowires and nanotubes can be provided by growing them in a template, which allows an easy and well-controllable definition of the pattern of nanostructures as described in for instance Schönenberger et al., J. Phys. Chem. B, 101 (1997), 5497-5505. The nanowires can be grown by known methods such as electrochemical growth and the Vapour-Liquid-Solid Method as described for instance in Morales and Lieber, Science, 279(1998), 208-211.

The variable optical component using bendable nano-elements can be used in an optical head suitable for optical storage applications. When for example the radiation source in the optical head, i.e. a semiconductor laser, is at a high power level mode for data recording or data erasing, the nano-elements would preferably have a substantially non-bent state to have the least effect on the intensity distribution of the radiation beam.

When the laser is in the low power mode for e.g. reading, a driver-field can be applied to the variable optical component such that the nano-elements come into a bent state. This results in absorption of the incident radiation. Therefore the laser can be operated on a higher power level with less noise and thus a better SNR and readout quality. The radiation feedback into the laser is reduced.

In an embodiment of the invention the variable optical component is positioned between the radiation source and the beam splitter in the optical head. The beam splitter, positioned between radiation source and objective lens, is used in the optical head to split the radiation beam towards the medium of the optical storage application from the radiation beam reflected from the medium. This reflected radiation beam is directed towards a radiation detection means for generating for example data and/or servo signals. It is preferred that the variable optical component is positioned between the radiation source and the beam splitter to vary the radiation intensity distribution of the radiation beam towards the objective lens. When the variable optical component would be positioned between beam splitter and objective lens, the radiation beam would be passing the component twice and therefore also affecting the radiation beam reflected by the medium resulting in reduction of the signals from the radiation detector.

In another embodiment the optical head comprises a variable optical component in which the bendable nano-elements have a non-uniform density over the cross section. In this situation it is possible to a varying absorption level over the cross section. When the center portion of the cross section is stronger attenuated than the outer portion due to a higher density of bendable nano-elements in the center portion than in the outer portion, the radiation intensity in the center portion is reduced with respect to the radiation intensity of the outer portion. Consequently the rim-intensity of the radiation beam and thus in the pupil of the objective lens is increased. This has advantages on the readout resolution, as it will suppress the secondary maxima (side lobes) of the radiation spot focused in the medium.

Another advantage of such an embodiment is that the numerical aperture of the coupling optics for the radiation out of the radiation source can be increased with respect to the unaffected radiation beam without a decrease of the rim-intensities. This can be advantageous even in the write mode of the laser, as the total radiation power in the radiation beam towards the objective lens can be increased compared to a situation with a lower numerical aperture and no absorption of the bendable nano-elements when the laser is in write mode. The radiation power loss due to this radiation intensity modification can be less than the radiation power gain due to larger coupling aperture resulting is an overall radiation power gain on the disc. This is an alternative for a lens or prism-type beam shaper without their tight alignment tolerances.

The bendable nano-elements can also be distributed in a substantially uniform density over the cross section. Then the absorption levels can be substantially uniform over the cross section, resulting in an attenuation of the radiation beam. When the laser (as radiation source) is at a high power level for a write mode the bendable nano-elements are set in a substantially non-bent state resulting in a low absorption level, and when the laser is at a low power level for a read mode the bendable nano-elements are set to a bent state resulting in absorption. This absorption level can be set such that the laser power in the read mode is at a low laser noise operation level.

Further possible embodiments the variable optical component has an electrode configuration that is segmented or the distribution of the nano-elements is segmented. Each segment can be associated with a driver-field that can be different in strength from the other driver-fields. In this way, when the driver-fields are applied, the resulting bending angle can be different for each segment. Therefore each segment in the cross-section can have a different impact on the variation of the radiation intensity distribution of the radiation beam that is incident on the device. The segmentation can be for example in pixels, annular rings or any other usable pattern to adapt the radiation intensity of the radiation beam.

The advantages of an optical storage apparatus using an optical head equipped with a variable optical component are clear for each mode reading or writing. In the read mode a high quality readout performance of the optical storage medium is achieved. When using a variable optical component as described in the embodiments showing the capability of beam-shaping the radiation beam, also the write performance can be improved.

It is also possible to apply a single device in an optical head utilizing multiple lasers, for example with different wavelengths such as used in a multi disc format compatible optical head. Having the laser controller linked to the controller of the variable optical device it is possible to control the settings per operating laser. These settings can thus be different for each operating laser.

These and other aspects of the invention will be explained further with reference to the below figures.

### BRIEF DESCRIPTION OF THE DRAWINGS

The Figures are not drawn to scale and are purely schematic. The same reference numbers in different figures refer to the same elements.

FIG. 1 shows schematically a cross section of a variable optical component having bendable nano-elements in their non-bent state,

FIG. 2 shows schematically a cross section of a variable optical component having bendable nano-elements in their bent state,

FIG. 3 shows a diagram of a device for scanning a medium in which device a variable optical component according to the invention is used,

FIG. 4 shows a variable optical component with a non-uniform distribution of bendable nano-elements,

FIG. 5 shows examples of variable optical components with segmentations in the distribution of bendable nano-elements or electrodes,

FIG. 6 shows an example of an alternative construction for the variable optical component based on a stack of substrates comprising bendable nano-elements, and

FIG. 7 shows a diagram of a device for scanning a medium in which device a variable optical component is used in combination with means to control the variable optical component.

### DETAILED DESCRIPTION OF THE PREFERRED EMBODIMENTS

In FIG. 1 a schematic presentation is given of a variable optical component 10 to show the principles of operation of a variable optical component with bendable nano-elements. The variable optical component comprises a substrate 4, which is in this case a glass substrate that is at the bottom side provided with a polarizer 5 and at the opposite site with electrodes 1, 2 and bendable nano-elements 3. For a transmission type variable optical component the electrodes may be made of, for example indium tin oxide (ITO). In this example a dielectric layer 6 of SiO2 covers the electrodes. The function of the layer is twofold: firstly, it planarizes the substrate 4, which simplifies the application of bendable nano-elements, and secondly, it acts as insulating barrier between the bendable nano-elements 3 and the electrodes 1, 2. In this way the bendable nano-elements will be influenced by an electric field only, and not by direct electrical contact with the electrodes 1, 2.

The bendable nano-elements 3 are in this example carbon nanotubes that have been functionalized with Si(OR)₃ groups, wherein R is methyl. Functionalization of carbon nanotubes with suitable end-groups is known per se from Langmuir, vol 16 (2000), pp 3569-3573. Therein, single walled carbon nanotubes of desired length are suspended with ultra-sonification in alcohol. The carbon nanotubes have been given carboxylic end groups by oxidation. This end group is then substituted through chemical reaction with Si(OR)₃.

In order to achieve a patterned deposition, the substrate is covered with a photoresist, which is developed according to a desired pattern. Then, the photoresist material and substrate are undergoing a plasma treatment process so as to make the substrate more hydrophilic and the photoresist more hydrophobic. A suitable treatment is a sequence of an oxygen plasma treatment, a fluor plasma treatment and an oxygen plasma treatment. Bundles of carbon nanotubes will align along the surface, due to the hydrophobic interactions between the individual carbon nanotubes. As an alternative to the use of a photoresist, a mask of another material may be used to obtain the required pattern. The pattern may also be obtained by burning away carbon nanotubes according to a desired pattern by means for example of a laser bundle having sufficient intensity.

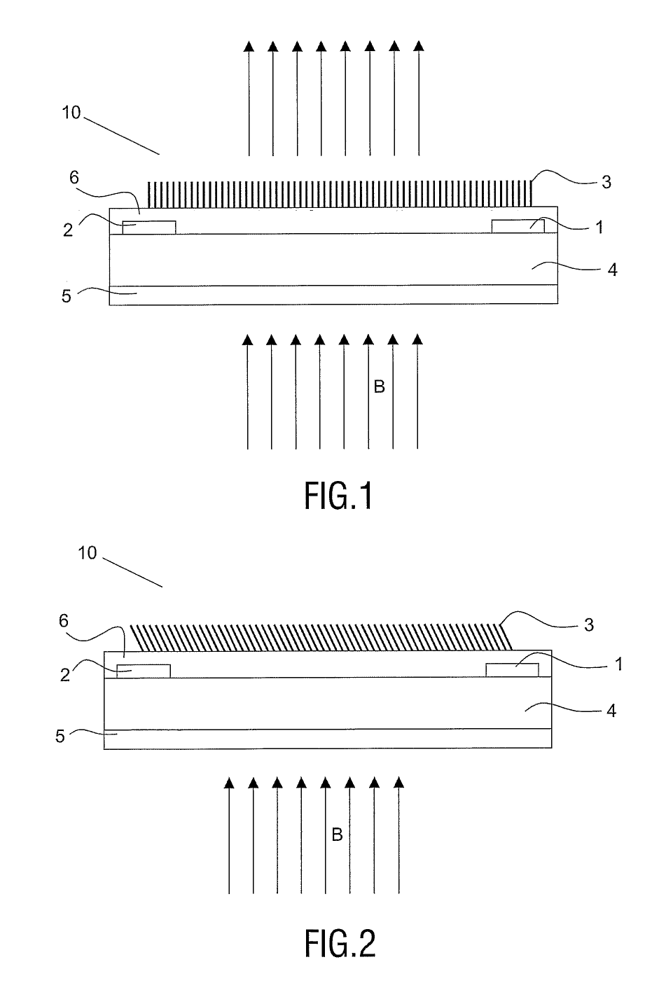

In case the applied electric field is zero, i.e. no voltage supplied to the electrodes 1 and 2, the nano-elements 3 are aligned perpendicular to the substrate 4. A radiation beam B incident on the variable optical component 10 in a direction normal to the substrate surface will pass the variable optical component substantially unhindered as the nano-elements are aligned parallel to the propagation direction of the radiation. If the electrical field is switched on, the nano-elements will bend and become curved nano-elements as shown in FIG. 2. The curved nano-elements now cover at least a substantial part of the area between the electrodes 1 and 2 and absorb that component of the beam B that has a polarization direction parallel to the tangent of the curved nano-elements. The absorption of an incident beam B will be maximal if the beam is a linearly polarized beam having its polarization direction tangent to the curved nano-elements. If the radiation beam is already sufficiently linearly polarized, such as a radiation beam originating from a semiconductor laser diode, the polarizer 5 may be omitted. The variable optical component is then preferably oriented in such a direction that the bending direction of the nano-elements matches the polarization direction of the radiation beam.

The nano-elements can be bent by means of an electric field having a strength in the range from 0.1 to 5 V/μm. The voltage for generating the electrical field may be a DC voltage. However, an alternating current with a frequency between a few Hz and some kHz, preferably about 50 Hz (e.g. the mains frequency), can be used.

In general a variable optical component, for example such as described above with reference to FIG. 1, may be of a transmission type or a reflection type. The transmission type variable optical component as described above can be converted into a reflective type by using, for example, a reflective substrate or by arranging a reflective layer between the substrate and the electrode configuration. This reflective layer may have optical characteristics as used in optical beam splitters or fixed apodisation filters having wavelength depend characteristics, e.g. for one wavelength range the layer is transmittive and for another wavelength range it is reflective.

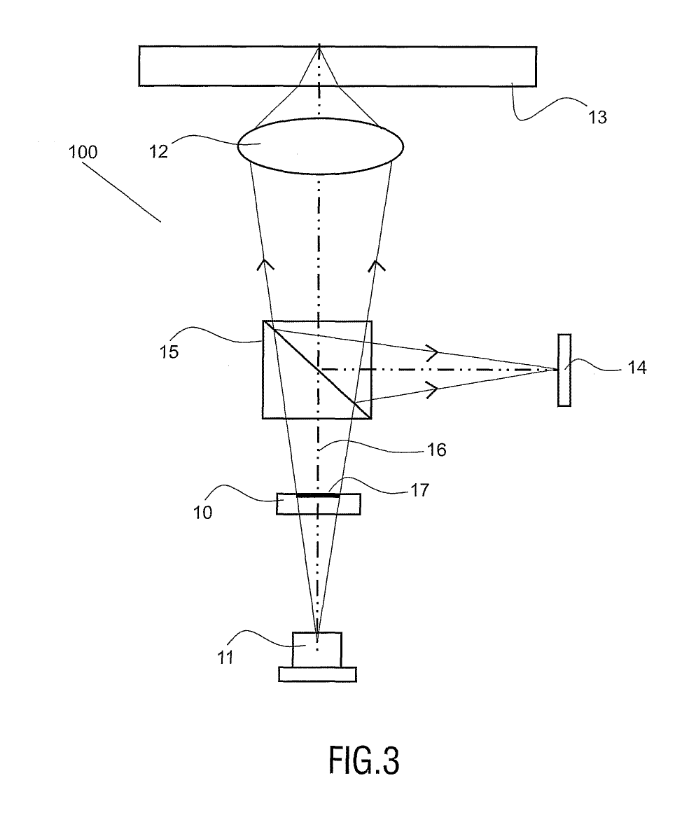

In FIG. 3 an optical head 100 is schematically shown in combination with a storage medium 13. It illustrates an optical system according to a first embodiment of the invention. The optical head 100, which can be used in an optical storage apparatus, comprises a radiation source 11 for generating a radiation beam, a variable optical component 10, a beam splitter 15, an objective lens 12 used as a lens for focusing the radiation beam onto a medium and a radiation detector 14. In this example the medium is an optical storage medium. A radiation beam emitted from the radiation source 11 is incident on the variable optical component 10, and the radiation beam transmitted through the variable optical component 10 is incident on the beam splitter 15. The radiation beam transmitted through the beam splitter enters an objective lens 12 that focuses the radiation beam onto a data layer of the optical storage medium (optical disc) 13. This optical disc can be a read-only disc, such as CD-ROM or BD-ROM, or a disc on which data recordings can be made such as DVD+R or DVD+RW. The radiation reflected from the data layer of the optical disc 13 enters the objective lens 12 and is split by the beam splitter 15 from the radiation beam of the radiation source 11 and directed towards the radiation detector 14. This radiation detector may be used for data signal generation and/or servo signals generation such as a focusing and tracking signal.

The variable optical component 10 appropriately varies the intensity distribution of the radiation beam emitted by the radiation source 11 when it is transmitted through the variable optical component. In a read mode the variable optical component can be set in an ‘on-state’ with the nano-elements in a bent state, in order to be able to attenuate the radiation beam incident on the variable optical component. The attenuation of the variable optical component is set at such a level that the radiation source is operating at a sufficiently low laser noise level, while maintaining a usable radiation intensity level on the radiation detector for the signals generation. In a write mode the variable optical component can be set in an ‘off-state’ with the nano-elements in a substantially non-bent state, such that the radiation beam transmitted through the variable optical component is substantially unaffected.

When the variable optical component 10 is positioned in the optical path between the beam splitter 15 and the objective lens 12, the radiation emitted from the radiation source and reflected by the optical disc 13 will reach the radiation detector 14 while passing the variable optical component 10 twice. In a read mode with the variable optical component in an on-state the radiation intensity distribution will have been varied twice. This may result in a radiation intensity level on the radiation detector that is too low for good quality servo and or data signals. Therefore it is preferable to position the variable optical component 10 in the optical path between the radiation source 11 and the beam splitter 15 as in that case the radiation emitted from the radiation source and reflected by the optical disc 13 will reach the radiation detector 14 while passing the variable optical component 10 only once and thus a higher radiation intensity level is achieved compared to the variable optical component position between radiation source and beam splitter.

In an embodiment of the invention the variable optical component has a substantially uniform distribution of bendable nano-elements. When the variable optical component is in an on-state during a read mode, the absorption, due to the bent nano-elements, is substantially homogeneous over the cross section of the radiation beam with the variable optical component. In this case the radiation intensity distribution of the transmitted radiation beam is attenuated. The electric field (driver-field) determining the bending angle of the bendable nano-elements depends on the applied voltage over the electrodes and the electrode configuration. The applied voltage therefore determines the attenuation of the radiation beam. When the variable optical component is applied in an optical head, the variable optical component can be in an off-state during a write mode in which the bendable nano-elements are in the substantially non-bent state. To obtain a high radiation power level onto the medium during the write mode the coupling efficiency, which is the ratio of the amount of radiation power coupled into the optics over the total emitted radiation power output of the radiation source, can be set at a high level by using a high numerical aperture for the coupling of the radiation into the optics towards the medium. In a read mode the high coupling efficiency can result into such a low radiation power emitting level that the radiation source is not operating in a stable output power range resulting in output power noise. Increasing the radiation output of the radiation source to such a value that the noise is at an acceptable level, can result in too much radiation power focused on the medium. To reduce the noise in the emitted beam out of the radiation source and still keep the level of the radiation power onto the medium at a low enough level, the transmission of the radiation path from radiation source to the medium needs to be reduced. The transmission of the variable optical component can be set such that the output power level of the emitted radiation beam during the read mode results in a sufficient low noise level in the emitted beam out of the radiation source without having a too high radiation power level onto the medium.

As an example, some data based on the results from a study of Li et al. (Li, Z. M. et al., Phys. Rev. Lett. 87(2001), 1277401-1/4) are used to design an attenuator using a substantially uniform distribution of bendable nano-elements. At a wavelength of 405 nm (corresponding to a photon energy of about 3.1 eV) the absorption for a radiation beam with a polarization perpendicular to the bendable nano-element axis is about 40% (absorption OD˜0.35), while the transmission for the polarization direction parallel to the bendable nano-element axis is about 0% (absorption OD˜5.5). These figures are based on a specific density of bendable nano-elements as well as dimensions of the bendable nano-elements.

The transmission T of the system can be written in a dependency of the absorption coefficient α and L as a measure for the dimensions of the bendable nano-elements according to

T˜e^{-α,L} (1)

The optical density OD, which is the logarithm of the transmission T, is therefore linearly dependent on αL. From the data of the publication of Li et al. the ratio of the OD for the radiation polarization direction parallel to the axis of bendable nano-elements and the OD for the radiation polarization direction perpendicular to the axis of the bendable nano-elements is found to be about 15. This ratio can be used when considering other configurations with other densities and dimensions of bendable nano-elements.

A configuration with a transmission of about 0.1% (OD=3) for a radiation beam with a polarization direction parallel to the axis of bendable nano-elements will, using said ratio, result in a transmission of about 63% (OD˜0.2) for a polarization perpendicular to the axis of the bendable nano-elements. A configuration with a transmission of about 10% (OD=1) for a radiation beam with a polarization direction parallel to the axis of bendable nano-elements will result in a transmission of about 86% (OD˜0.067) for a polarization perpendicular to the axis of the bendable nano-elements.

As intermediate bending angles for the bendable nano-elements are possible, so, between non-bent and fully bent, not the fall range of the ratio may be used in an application. For each application the driver-field or driver-fields can be tuned to such a level that the bending angles result in the required absorption level.

It may be possible, that to achieve a sufficiently homogenous absorption over the cross section with the radiation beam, multiple electrodes are required to generate substantially the same bending angles for all the nano-elements in that cross section.

In another embodiment of the invention the variable optical component has a non-uniform distribution of bendable nano-elements. Such a non-uniform distribution of bendable nano-elements does not have to be rotational symmetric. It can have any distribution suitable for the application, for example, a density distribution variation in one direction and in a direction perpendicular to said one direction a uniform density distribution.

FIG. 4 shows a schematic example of a cross section of such a variable optical component 10 having a non-uniform distribution of bendable nano-elements 3. The density of bendable nano-elements in the center of the variable optical component is higher than in the outer region. The variable optical component in this example has a rotational symmetry along the optical axis 16. When the variable optical component is placed in a radiation beam of for example an optical head, and no driver-field is applied (off-state) such that the bendable nano-elements are in a substantially non-bent state with respect to the direction of the radiation beam passing the nano-elements, there is no absorption and thus no effect on the radiation intensity distribution of the passing radiation beam. This can be the state of the variable optical component during a write mode of the optical head, in which a high efficiency from radiation source to medium is required. When a driver-field is applied (on-state) between the electrodes 1, 2 the bendable nano-elements can be bent. When the bending direction is in the direction of the polarization of the radiation beam (so parallel to the polarization direction of the radiation beam), the absorption in the center part of the variable optical component will be larger than in the outer part. A first advantage is that the required radiation emitting power of the radiation source in a read-mode is increased to reduce the noise generated by the radiation source as discussed in previous embodiments. A second advantage is that the intensity distribution in the radiation beam is modified in such way that the rim-intensity is increased and thereby reducing the focus spot size on the medium, so, increasing the readout resolution (see also Tawa L. et al., SPIE Vol. 3864 (1999), p. 37-39).

For optical systems such as CD, DVD and BD the rim-intensity is important with respect to the read-out quality of the data from the disc. In applications such as optical recording the radiation source is an edge emitting semiconductor laser. The far field aspect ratio of these lasers is usually such that the beam divergence of the emitted beam in the direction parallel to the active layer of the laser is smaller than the beam divergence in the direction perpendicular to the active layer of the laser. Using a coupling lens to couple the emitted radiation beam into the optical system, the numerical aperture of this lens will be limited by the minimum requirements on the rim-intensity of the resulting radiation beam. This will be determined by the beam divergence angle in the parallel direction of the active layer of the laser. As a result the rim-intensity in the direction corresponding to the perpendicular direction will be high. This means that quite a substantial amount of emitted radiation will not be used (falling outside the numerical aperture of the coupling lens) especially in the direction corresponding to the perpendicular direction. The coupling lens can be integrated in the objective lens of the optical head. The objective lens is then of the finite conjugate type.

In conventional beam shaping optics usually anamorphic prisms are used to reshape the substantially elliptical radiation intensity distribution of the emitted radiation beam into a radiation beam with a more circular radiation intensity distribution. With the same requirement on the minimum rim-intensity more radiation can be coupled into the optical system. Such anamorphic prisms require a perfectly parallel beam at its entrance, therefore making a collimator lens between the radiation source and the beam shaper necessary. This means that additional optical components are needed in the readout and servo optical path of the optical head to focus the radiation reflected by the disc onto a detector. Furthermore there are positional stability requirements between the radiation source and the collimator lens; defocus of the laser with respect to the collimator lens will result in astigmatism in the beam exiting the anamorphic prism and thus in a reduction of the optical quality of the radiation beam.

It is also possible to increase the rim-intensity by reducing the intensity in the center part of the beam while substantially not affecting the intensity at the outer part (rim) of the beam by using for example a variable optical component such as shown in and discussed in relation to FIG. 4. In this situation the coupling efficiency can be increased by applying a relatively large numerical aperture for the coupling lens thereby reducing the rim-intensity, and accordingly reduce the intensity at the center portion of the radiation beam in order to end up with corrected (relative) rim intensities are obtained. For optical systems requiring high rim-intensities such as BD the loss of radiation due to the absorption in the variable optical component can be less than the gain in coupling efficiency due to the larger numerical aperture of the coupling lens. A gain in coupling efficiency of about 50% or more can be obtained in designs for such optical systems. In the above description the variable optical component will be in an on-state in the writing mode to obtain the required absorption in the central portion of the radiation beam passing the variable optical component.

The application of a variable optical component with beam shaper functionality does not require the tight tolerances as needed for anamorphic prisms or lens type beam shapers.

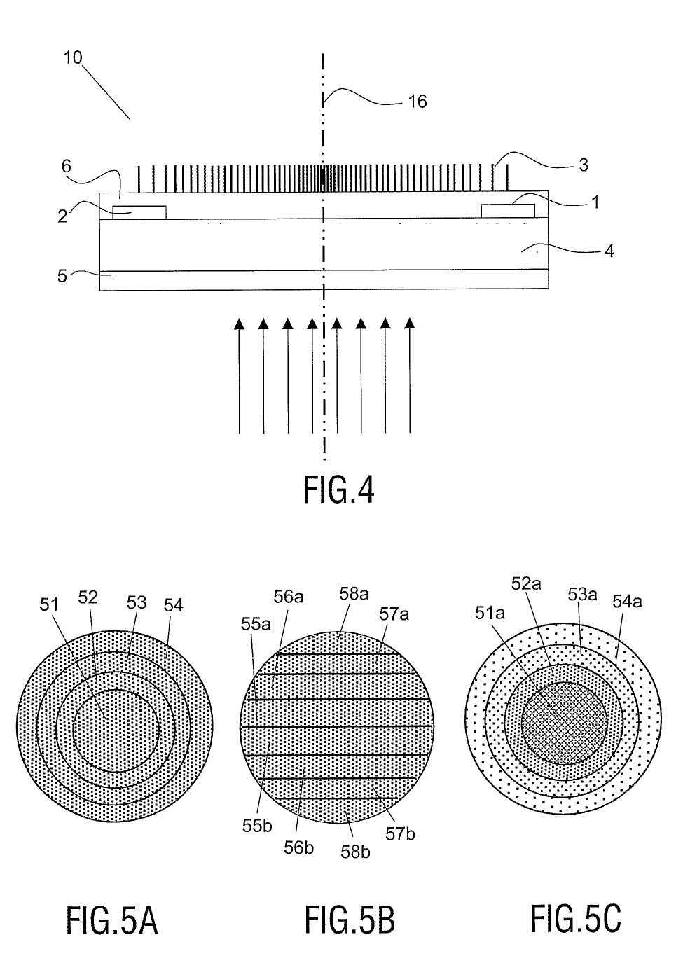

In both situations where the variable optical component has a uniform or a non-uniform distribution of bendable nano-elements, the electrode configuration for applying a driver-field or multiple driver-fields can be segmented. FIG. 5 shows some examples of possible segmentations for a variable optical component. The bendable nano-elements can be located within in a circular area, such as for example in circular cross section of the variable optical component with the radiation beam. In FIG. 5A annular segments 51, 52, 53, 54 of the electrode configuration in combination with a homogeneous density distribution of bendable nano-elements is schematically shown. Such a configuration gives, for example, the possibility to tune the absorption per segment per laser, because semiconductor lasers as applied in optical storage applications are not all identical. The radiation emission angles (FWHM) in both the parallel and perpendicular directions spread between production batches of the lasers. Another advantage is that when such segmented devices are in an optical head applying multiple lasers (for example, a red laser for DVD and a blue-violet laser for BD), the variable optical component segment absorptions can be differently tuned for each laser. The driver-field between the segments can then be adapted to fit to the requirements for each laser type. The number of segments is not limited to the number shown in the figure. In FIG. 5B an example is shown with segmentation in only one direction. Segments 55a and 55b, but also 56a and 56b, 57a and 57b, 58a and 58b, can be all addressed individually or as pairs. In the application this direction will most likely be in the direction of the parallel farfield of the laser, such that the rim-intensity in that direction can be increased. Although the previous description is related to electrode configurations it can also be related to segments of distributions of bendable nano-elements.

This segmentation can also be such that each segment can be individually addressed in order to apply a specific driver-field per segment. The driver-field can be different per segment per write and read mode. The segment can have any shape, such as square pixels, annular rings, or other shape. It is also possible that the distribution of bendable nano-elements is segmented, for example such as schematically shown in FIG. 5C. In the example of FIG. 5C the central segment 51a has a highest density of bendable nano-elements and in the outer segment 54a a lowest density of bendable nano-elements.

A similar effect as obtained with a non-uniform distribution of bendable nano-elements on the variable optical component can also be obtained when using a combination of a uniform intensity distribution and a non-uniform driver-field applied by a suitable electrode configuration. Due to the non-uniform driver-field applied the bending angle of the bendable nano-elements is not homogeneous over the cross section and thus is the absorption also not homogeneous over the cross section of the radiation beam.

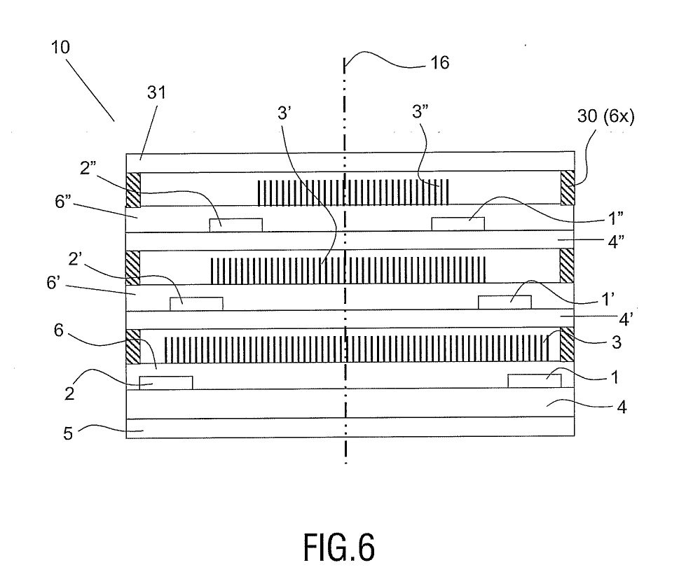

Variable optical components can be designed and made having combinations of the features described in this application. Furthermore it is also possible that the variable optical component comprises a stack of substrates with bendable nano-elements. In FIG. 6 an example of such a stacked device is shown. The individual substrates 4, 4′and 4″ comprise bendable nano-elements 3, 3′and 3″ as well as electrodes 1,2, 1′, 2′ and 1″, 2″ for applying a driver-field to the bendable nano-elements. The number of substrates is not limited to the amount shown in FIG. 6. The substrates with bendable nano-elements are separated by means of separators 30. In FIG. 6 six of such separators are shown. The separators can be of glass, plastic or any other suitable material. The top substrate 4″ with bendable nano-elements 3″ can be covered with a cover 31. The cover can be made of glass, plastic or other suitable transparent material. The stack as shown in FIG. 6 can be considered as a 3-dimensional segmentation of the variable optical component in the direction of its optical axis 16. The individual substrates (4, 4′, 4″) can comprise a uniform or non-uniform distribution of bendable nano-elements. It is also possible that each substrate with bendable nano-elements has segments with distributions of bendable nano-elements or comprises a segmented (multiple) electrode configuration. The electrodes on the substrates in the stack can be addressed simultaneously, i.e. as if it were a single stack, or individually.

An advantage of such a stack is that the bendable nano-elements can be distributed on the substrate in a uniform density, which is easier to manufacture than for example a non-uniform distribution of a bendable nano-elements in which the density of bendable nano-elements in the center of the variable optical component is higher than in the outer region. Also the functionality of a variable optical component such as example shown in FIG. 5c can be made with a device as shown in FIG. 6 using a stack with multiple substrates while each substrate has a uniform density distribution of bendable nano-elements.

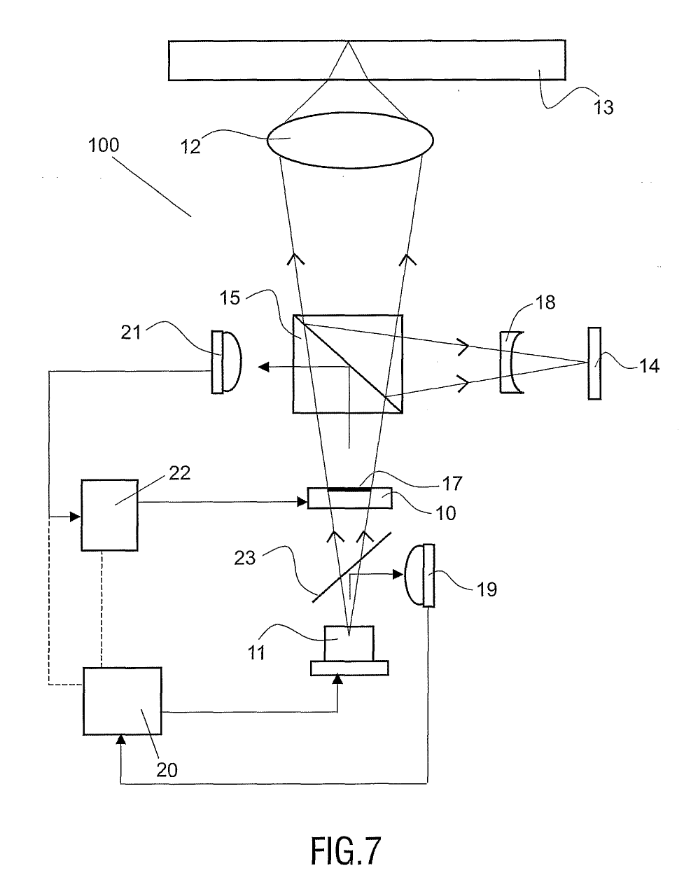

In FIG. 7 a schematic representation is given for a variable optical component 10 used in an optical head 100 including means for controlling the variable optical component as well as the amount of radiation out of the radiation source. The radiation source 11 emits a radiation beam passing the variable optical component 10. The transmitted radiation beam passes the beam splitter 15 and is coupled into the lens 12 that focuses the radiation beam onto a medium 13. The radiation reflected by the medium is passing the lens and directed by the beam splitter 15 towards a radiation detector 14. Making use of the astigmatism generated in the beam by means of a cylindrical lens 18 an astigmatic focusing method is possible. It is also possible to have a reflection type variable optical component in the optical head.

A forward sense detector 19 is positioned in a part of the emitted radiation beam to measure and control the radiation output of the radiation source. In this case part of the emitted radiation is directed towards the forward sense detector 19 via a beam splitter 23. The output signal of the forward sense detector is an input signal for the radiation source controller 20, which controls the amount of radiation out of the radiation source 11 to for example a read level and a write level.

The amount of radiation that has passed the variable optical component is also monitored using a monitor detector 21. This is, for example, to monitor the effect of the settings of the variable optical component in the read or write mode radiation power towards the medium. The output signal of the monitor detector 21 can be an input signal for a variable optical component controller 22. This variable optical component controller 22 controls the driver-field or fields of the variable optical component. These driver-field or fields are required to bend the bendable nano-elements of the variable optical component.

When the system is set in a read mode the radiation source controller 20 sets the radiation output of the radiation source at a predetermined value. Optionally this can be done making use of the signal from the forward sense detector 19. The variable optical component controller 22 sets the variable optical component 10 in a read mode. This can be a predetermined setting with respect to the driver-field or fields necessary to obtain the required absorption of the radiation beam passing the variable optical component. The monitor detector 21 can monitor the radiation beam power transmitted through the variable optical component. Fine-tuning of the settings of the variable optical component controller can be done using the output of the monitor detector 21. The radiation beam passes thought the lens 12 and is focused in the medium 13 to readout the data. The radiation reflected by the medium is transmitted through the lens 12 and directed towards the signal detector 14. Focusing of the radiation beam can be controlled by a commonly used focusing method, such as the astigmatic focusing method.

When the system is set in a write mode, the controller 22 sets the variable optical component 10 in a write mode. This can be such that there is substantially no absorption due to the bendable nano-elements, or such that there is absorption in a way that beam shaping is applied. The output power of radiation source 10 is set at a write power level by the radiation source controller 20. Radiation source controller 20 can make use of the output signal of the forward sense detector 19 during the settings and/or the read and/or write mode of the system. Also the variable optical component controller 22 can make use of the output signal of the monitor detector 21 during the settings and/or read and/or write mode of the system.

The monitor detector 21 can be a single detector or a segmented detector suitable for measuring the transmission of a single segment or multi-segment variable optical component. In case of a multi-segmented monitor detector it is possible to fine-tune each segment of the variable optical component 10 via its controller 21.

The radiation source controller 20 and variable optical component controller 22 as well as radiation source controller 20 and the monitor detector 21 may have electrical interactions in order to set the output power of the radiation source 11 and the setting of the variable optical component 10. The dashed lines in FIG. 7 represent such possible interactions. These electrical interactions have the advantage that timing of the settings of the radiation source output power and the settings of the variable optical component can be controlled in a better way. It is also possible that, with the radiation source controller linked to the controller of the variable optical component, the settings can be controlled and/or tuned for a multiple of radiation sources in the optical head.

This radiation source controller 20 and/or the variable optical component controller 22 can be located on the optical head or on in another part of the optical system comprising the optical head.

The variable optical component can be positioned in radiation beam having a vergence or in a parallel beam parallel beam.

The variable optical components as described can also be used in other optical applications were a radiation beam intensity is to be modified. Such applications can for example be laser printers, microscopy, etc.

1. An optical head (100) comprising:
a radiation source (11) for emitting a radiation beam,
a lens (12) for focusing said emitted radiation beam onto a medium (13), and
a variable optical component (10) for varying the intensity distribution of the radiation beam entering the lens (12),
said radiation beam having a cross section (17) at the location of the variable optical component (10),
characterized in that the variable optical component (10) comprises an electrode-configuration of electrodes (1,2) for generation of a driver-field, and bendable nano-elements (3) which are switchable between a non-bent state and a bent state by means of said driver-field.

2. An optical head (100) according to claim 1 further comprising a beam splitter (15), characterized in that the variable optical component (10) is positioned between the radiation source (11) and the beam splitter (15).

3. The optical head (100) according to claim 1, further characterized in that the bendable nano-elements (3) have a non-uniform density over the cross section (17).

4. The optical head (100) according to claim 1, further characterized in that the bendable nano-elements are located in segments (51,52,53,54, 55,56,57,58) over the cross section (17).

5. The optical head (100) according to claim 1, further characterized in that the electrode configuration is arranged in segments (51, 52, 53, 54, 55, 56, 57, 58) over the cross section (17).

6. The optical head (100) according to claim 1, characterized in that the variable optical component comprises a stack of substrates (4, 4′, 4″) with bendable nano-elements (3, 3′, 3″) arranged in the direction of the propagation of the radiation beam.

7. The optical head (100) according to claim 4, (10) further characterized in that the variable optical component (10) is arranged such that the radiation intensity in the center of the radiation beam is more affected than the intensity at the rim of the radiation beam.

8. A variable optical component (10) for use in the optical head (100) of claim 1, characterized in that the variable optical component has a configuration of electrodes (1,2) for generation of a driver-field, and bendable nano-elements (3) that are switchable between a non-bent state and a bent state by means of said driver-field.

9. An optical system using the optical head of claim 1 further comprising means (21) for controlling the driver-field of the variable component in response to switching between a write mode and read mode.
